(19) United States
(12) Patent Application Publication
(10) Pub. No.: US 2024/0250490 A1
(43) Pub. Date: Jul. 25, 2024

(54) HIGH ENERGY- HIGH FREQUENCY PULSED 2.94 MICROMETER DIODE PUMPED Er:YAG LASERS

(71) Applicant: 3 Micron Laser Technology, LLC, Indianapolis, IN (US)

(72) Inventor: Thong Thanh Nguyen, Indianapolis, IN (US)

(21) Appl. No.: 18/415,921

(22) Filed: Jan. 18, 2024

Related U.S. Application Data
(60) Provisional application No. 63/441,052, filed on Jan. 25, 2023.

(51) Int. Cl. H01S 3/06; H01S 3/094; H01S 3/0941; H01S 3/16

(52) U.S. Cl. CPC H01S 3/061; H01S 3/094076; H01S 3/0941; H01S 3/1608; H01S 3/1643

(57) ABSTRACT

Years of experimentation, testing, and refinement have resulted in designs for lasers that can produce laser beams that have a 2.94 μm wavelength and a previously unachievable output power of at least 220 W. Specific designs for such high power 2.94 μm lasers are presented herein such that those practiced in the art may achieve similar results without undue experimentation. Such a laser can include a laser rod and at least one laser pump source. The laser pump source is configured to pump energy into the laser rod to thereby cause the laser to produce a laser beam that has a wavelength of 2.94 μm. The laser beam has a maximum average power of at least 220 W. The laser beam includes a plurality of pulses that each have an energy of at least 1.5 J at 0.5 ms at 150 Hz.

### CROSS REFERENCE TO RELATED APPLICATIONS

This patent application claims the priority and benefit of U.S. provisional patent application No. 63/441,052, titled “HIGH ENERGY-PULSED 2.94 MICROMETER MONOLITHIC DIODE PUMPED Er:YAG LASERS” filed on Jan. 25, 2023. U.S. provisional patent application No. 63/441,052 is herein incorporated by reference in its entirety.

### TECHNICAL FIELD

The disclosed systems and methods are generally related to diode pumped lasers, infrared lasers, side pumped solid state lasers, and to lasers that use arrays of laser diodes to pump a rod of gain media.

### BACKGROUND

Diode-pumped solid-state lasers have been produced using rod shaped gain media. U.S. Pat. No. 9,368,931, hereinafter Bragagna, teaches a laser in which the gain media is a rod having a diameter of less than 3 mm. In fact, Bragagna teaches that the rod diameter is preferably less than 2 mm such that Bragagna's preferred embodiment has a diode laser pump power within the laser active medium between 20 Watts (W) per cubic mm and 500 W per cubic mm. In Bragagna's preferred embodiment the intra cavity laser intensity (within the laser active medium) is between 5 kW per centimeter squared and 10 MW per centimeter squared. Bragagna's laser obtains high pump power density by limiting the cross-section area and length of the rod to thereby concentrate the pump power density. Bragagna suggests a cross section below 7.5 square mm, which corresponds to a rod having a 2.39 mm diameter. A side effect of Bragagna's technique is that the laser average power is limited by the ability of the rod to withstand the amount of pump power inside the laser active medium because too much pump power breaks the rod.

### SUMMARY

The following summary is provided to facilitate an understanding of some of the innovative features unique to the examples disclosed and is not intended to be a full description. A full appreciation of the various aspects of the examples can be gained by taking the entire specification, claims, drawings, and abstract as a whole.

One aspect of the subject matter described in this disclosure can be implemented in a system. The system can include a laser that includes a laser rod and at least one laser pump source, wherein the laser pump source is configured to pump energy into the laser rod to thereby cause the laser to produce a laser beam that has wavelength of 2.94 μm, the laser beam has a maximum average power of at least 220 W, the laser beam includes a plurality of pulses that each have an energy of at least 1.5 J.

Another aspect of the subject matter described in this disclosure can be implemented in a method. The method can include pumping energy into a laser rod to thereby cause a laser to produce a laser beam that has wavelength of 2.94 μm, wherein the laser beam has a maximum average power of at least 220 W; and the laser beam includes a plurality of pulses that each have an energy of at least 1.5 J.

Yet another aspect of the subject matter described in this disclosure can be implemented in a system. The system can include a laser that includes at least one laser pump source, and a laser rod, wherein the laser rod has two concave faces that each have a radius of curvature that is at least 200 mm and no more than 500 mm, the at least one laser pump source is configured to pump energy into the laser rod to thereby cause the laser to produce a laser beam that has wavelength of 2.94 μm, and the laser beam has a maximum average power of at least 220 W.

In some implementations of the methods and devices, the laser rod is a 50% doped Er:YAG laser rod. In some implementations of the methods and devices, the laser rod has two concave faces that each have a radius of curvature that is at least 200 mm and no more than 500 mm. In some implementations of the methods and devices, a pump power density of the laser rod is no more than 30 W per cubic mm while the laser rod is producing the laser beam. In some implementations of the methods and devices, the laser rod has a laser rod diameter that is at least 4 mm and no more than 5 mm. In some implementations of the methods and devices, a full divergent angle of the laser beam is no more than 50 mrad. In some implementations of the methods and devices, the laser rod is a 50% doped Er:YAG laser rod that has a laser rod diameter that is at least 4 mm and no more than 5 mm. In some implementations of the methods and devices, a pump power density of the laser rod is no more than 30 W per cubic mm while the laser is producing the laser beam. In some implementations of the methods and devices, the pulses each have an energy of at least 2.2 J. In some implementations of the methods and devices, the laser rod is a 50% doped Er:YAG laser rod that has a laser rod diameter that is at least 4 mm and no more than 5 mm and a laser rod length that is at least 126 mm and no more than 188 mm. In some implementations of the methods and devices, the laser rod is an Er:YAG laser rod, a pump power density of the laser rod is no more than 30 W per cubic mm while the laser rod is producing the laser beam, the laser rod has a laser rod diameter that is at least 4 mm and no more than 5 mm, the laser rod has a laser rod length that is at least 126 mm and no more than 188 mm, a pumping length of the laser that is at least 60 mm and no more than 120 mm, and a full divergent angle of the laser beam is no more than 50 mrad.

In some implementations of the methods and devices, the laser rod is an Er:YAG laser rod. In some implementations of the methods and devices, a pump power density of the laser rod is no more than 30 W per cubic mm while the laser rod is producing the laser beam. In some implementations of the methods and devices, the laser rod has a laser rod diameter that is at least 4 mm to 5 mm and laser rod length is in a range of 126 mm and no more than 188 mm. In some implementations of the methods and devices, a full divergent angle of the laser beam is no more than 50 mrad.

In some implementations of the methods and devices, the laser beam includes a plurality of pulses that each have an energy of at least 1.5 J. In some implementations of the methods and devices, the at least one laser pump source is five laser diode packages that pump energy into the laser rod. In some implementations of the methods and devices, the laser further includes a flat output coupler, and a flat high reflector.

### BRIEF DESCRIPTION OF THE DRAWINGS

The accompanying figures, in which like reference numerals refer to identical or functionally-similar elements throughout the separate views and which are incorporated in and form a part of the specification, further illustrate the examples and, together with the detailed description, serve to explain the examples disclosed herein.

FIG. 1 is a high-level conceptual diagram illustrating an end view of an example of a solid-state laser according to some aspects.

FIG. 2 is a high-level conceptual diagram illustrating a side view of the solid-state laser illustrated in FIG. 1 according to some aspects.

FIG. 3 is a diagram illustrating an end view of a rod of gain media, also called a laser rod, according to some aspects.

FIG. 4 is a diagram illustrating a side view of the laser rod illustrated in FIG. 3 according to some aspects.

FIG. 5A is a diagram illustrating a concave end of a laser rod, according to some aspects.

FIG. 5B is a diagram illustrating a concave anti-reflective end of a laser rod, according to some aspects.

FIG. 6A is a diagram illustrating an example of an output coupler, according to some aspects.

FIG. 6B is a diagram illustrating an example of a high reflector, according to some aspects.

FIG. 7 is a diagram illustrating a top-hat spatial profile of a laser beam that has been achieved using a laser that has a 50% doped Er:YAG laser rod with a laser rod length of 188 mm and a laser rod diameter of 5 mm, according to some aspects.

FIG. 8 is a diagram illustrating a temporal profile of the output beam of a laser that has a 50% doped Er:YAG laser rod with a laser rod length of 188 mm and a laser rod diameter of 5 mm, according to some aspects.

Throughout the description, similar reference numbers may be used to identify similar elements.

### DETAILED DESCRIPTION

The particular values and configurations discussed in the following non-limiting examples can be varied and are cited merely to illustrate one or more examples and are not intended to limit the scope thereof.

Examples will now be described more fully hereinafter, with reference to the accompanying drawings, in which illustrative examples are shown. The examples disclosed herein can be implemented in many different forms and should not be construed as limited to the examples set forth herein; rather, these examples are provided so that this disclosure will be thorough and complete, and will fully convey the scope of the disclosure to those skilled in the art. Like numbers refer to like elements throughout.

The terminology used herein is for the purpose of describing particular examples only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one example” as used herein does not necessarily refer to the same example and the phrase “in another example” as used herein does not necessarily refer to a different example. It is intended that the claimed subject matter include combinations of the examples in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that the examples described herein are shown by way of illustration and not as limitations of the claims. The principal features can be employed in various examples without departing from the scope of the claims. Those skilled in the art will recognize, or be able to ascertain using no more than routine experimentation, numerous equivalents to the specific procedures described herein. Such equivalents are considered to be within the scope of the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All the systems and methods disclosed and claimed herein can be made and executed without undue experimentation in light of the present disclosure. Dimensions or ranges illustrated in the figures are exemplary, and other dimensions may be used. It will be apparent to those of skill in the art that variations may be applied to the systems and to the steps or the sequence of steps of the methods described herein without departing from the concept, spirit, and scope. All such similar substitutes and modifications apparent to those skilled in the art are deemed to be within the spirit, scope and concept of the claims.

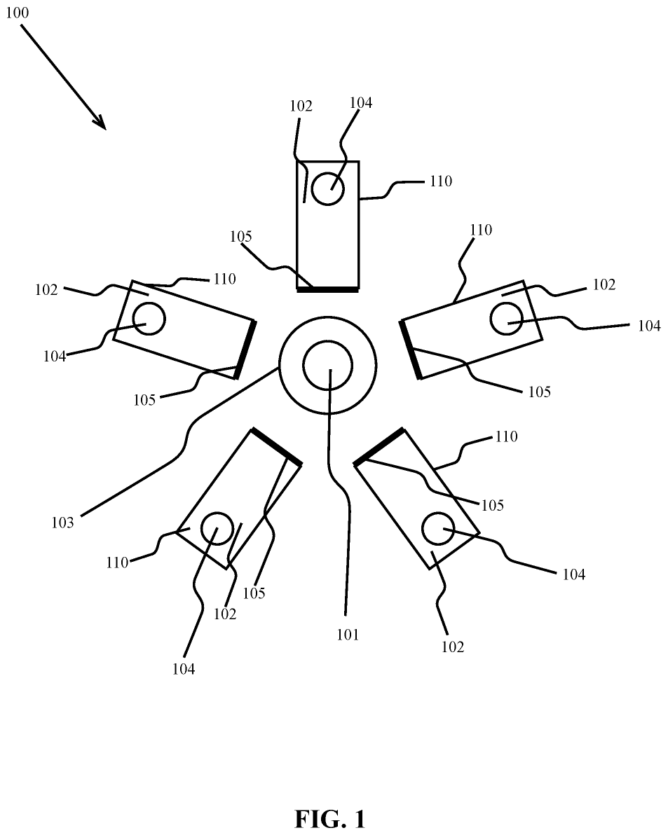

The examples and descriptions herein are directed to methods and systems for high energy pulsed 2.94 micrometer (μm) diode pumped lasers. Such lasers can be Erbium-doped Yttrium Aluminum Garnet (Er:YAG) lasers. Components of the systems can include a laser rod, a laser pump source (e.g., laser diode arrays, flash lamp, etc.), laser diode drivers, DC power supplies, a laser controller, and a refrigerating water chiller. The DC power supplies provide electrical power to the laser diode drivers and the laser diode drivers drive the laser diode array pump sources. The laser diode array pump sources pump optical energy into the laser rod thereby causing the laser to lase and to emit an output beam. The output beam is a laser beam. The laser rod may be a 50% doped Erbium in Yttrium Aluminum Garnet (Er:YAG) rod. In an example, the laser head includes a laser rod, five laser diode packages that pump the laser rod, and a laser cavity that includes an output coupler and a high reflector. The laser diode packages may be oriented radially every 72 degrees around the laser rod, as shown in FIG. 1. The laser rod may be positioned inside a flow tube such that chilled water flowing through the flow tube cools the laser rod. A laser diode package may include a laser diode array and a copper block. The laser diode array may be mounted on the front face of the copper block of the laser diode package. The copper block can act as a heatsink for the laser diode arrays. The chilled water may cool the copper block by, for example, flowing inside a cooling channel in the copper block of the laser diode package (e.g., in a rear portion of the laser diode packages). The DC power supplies can supply DC power to the laser diode drivers. The laser diode drivers can drive the laser diode arrays in a pulsed mode to thereby produce laser pumping radiation (e.g., laser light from laser diode arrays) as a series of light pulses to the laser rod. Those practiced in lasers are familiar with laser pump sources such as laser diode packages.

This Er:YAG laser system emits a 2.94 μm laser beam. As those practiced in the art understand, a 2.94 μm laser beam is a laser beam that has a wavelength centered at 2.94 μm. Examples that have been produced and that are disclosed herein have a good top-hat beam quality, full divergent angle of 50 mrad, and optical to optical efficiency of 14% or better. Testing has shown that reliable lasers can be produced that have average output powers of 220 W. The laser beam is a pulsed laser beam. Pulsed laser beams have periodic pulses of light. Examples discussed herein have pulse energies from 1.5 J to 2.2 J and a 0.5 ms pulse length. The repetition rate (also called the pulse repetition frequency) is from 100 Hz to 150 Hz. The maximum peak powers are 3 kW and 4.4 kW, respectively.

The highest output pulse energy of a 2.94 μm diode pumped Er:YAG laser of a different design that is currently available in the laser market is 3.5 J at 1 ms pulse duration and a 23 Hz repetition rate. That laser produces a poor-quality beam (relative to the design disclosed herein) because the beam has a less even and defined “top-hat” intensity pattern and has a full divergent angle of 100 mrad. The defense industry cannot use that laser because of its large divergent angle and low repetition rate. The defense industry needs 2.94 μm diode-pumped Er:YAG lasers with output pulse energy of multiple Joules, a beam full divergent angle of 50 mrad or less, and frequency of 100 Hz or more. Examples of the 220 W average power Er:YAG using the design disclosed herein can produce laser beams with pulse energies of 2.2 J at 0.5 ms at 100 Hz or 4.4 J at 1 ms at 50 Hz, and a 50 mrad divergent angle. This is currently the highest output pulse energies from a 2.94 μm diode-pumped Er:YAG laser. Those practiced in lasers understand that a laser beam can be described by specifying a pulse energy (the energy in each pulse) at a pulse width (the width of each pulse in the time domain) at a repetition rate (the number of pulses in a time period). As such, a laser beam with a pulse energy of 2.2 J at 0.5 ms at 100 Hz is a laser beam in which each pulse has 2.2 J of energy, each pulse is 0.5 ms long, and there are 100 pulses per second.

An example of the 220 W average power laser has a 50% doped Er:YAG laser rod that is 188 mm long and 5 mm in diameter. The laser has a pumping length (length of the section of the laser rod that receives energy from the pumping lasers) of 120 mm. The laser is pumped by five pumping laser diode packages that are rated to produce a maximum of 36 kW of optical power in total, having a 979 nm center frequency and a 4 nm bandwidth. The laser's maximum duty cycle is 5%. The laser produces a laser beam at the wavelength of 2.94 μm with pulse energy of 2.2 J at 0.5 ms pulse duration and at a 100 Hz rate. The 36 KW of optical power can be the total power of numerous laser pump sources. For example, each of the five pumping laser diode packages can produce 7.2 kW of optical power such that the five pumping laser diode packages can produce 36 kW of optical power in total.

The laser gain medium of the example can be an Er:YAG rod that is 50% doped, has a 5 mm diameter, has a 188 mm length, and the end faces of the rod are concave-concave. The radius of curvature (ROC) of these concave faces is in the range of 200 to 500 mm, the centers of these ROCs are on the principal axis of the laser rod. These concave faces of the laser rod can be anti-reflection coated such that the reflectivity of the concave faces is less than 0.1% at a 2.94 μm wavelength. These concave faces partially cancel the thermal lensing in the laser rod which is created by the absorption of the light from the laser diode packages. This cancellation of the thermal lensing helps the laser to run at high pulse energy and high frequency. The laser cavity includes a flat output coupler and a flat high reflector. The output coupler can be coated with a material such that it partially reflects 2.94 μm wavelength light at an incident angle of zero degrees. The reflectivity of the output coupler's reflective coating at 2.94 μm at an incident angle of zero degrees is in the range of 90% to 94%. As such, the partially reflecting face is less reflective than other designs such as Bragagna's design. The high reflector can be coated with a material such that it is highly reflective of light at 2.94 μm at an incident angle of zero degrees. The reflectivity of the high reflector's reflective coating at 2.94 μm at an incident angle of zero degrees can be greater than 99.9% at 2.94 μm. The distance between the output coupler and the high reflector, called the cavity length, can be 208 mm. The output coupler and the high reflector may be angularly tuned in two directions that are normal to the principal axis of the laser rod (e.g., along the vertical axis and along the horizontal axis).

Another example of a 220 W average power laser has a 50% doped Er:YAG laser rod that is 126 mm long and 5 mm in diameter. The laser has a pumping length (length of the rod receiving energy from the pumping lasers) of 60 mm. The laser rod can be pumped by five pumping laser diode packages rated to produce a maximum of 24 kW of optical power in total and at a 979 nm center frequency and 4 nm bandwidth. The laser's maximum duty cycle may be 7.5%. The laser can produce a laser beam with a 2.94 μm wavelength, pulses having pulse energy of 1.5 J at 0.5 ms pulse duration, and at a 150 Hz repetition rate. The 24 kW of optical power can be the total power of numerous laser pump sources. For example, each of the five pumping laser diode packages can produce 4.8 kW of optical power such that the five pumping laser diode packages can produce 24 kW of optical power in total.

The laser gain medium of the example can be a 50% doped Er:YAG rod. The diameter of the rod is 5.0 mm. The length of the rod is 126 mm. The rod has two end faces that are concave-concave. The radius of curvature (ROC) of the concave faces is in the range of 200 to 500 mm, the centers of these ROCs are on the axis of the rod. The concave faces of the laser rod are anti-reflection coated to have a reflectivity of less than 0.1% at a wavelength of 2.94 μm. The concave faces partially cancel the thermal lensing in the laser rod which is created by the absorption of the light from the laser diode packages. This cancellation of the thermal lensing helps the laser run at high pulse energy and high frequency. The laser cavity includes a flat output coupler and a flat high reflector. The output coupler can be coated with a material such that it partially reflects 2.94 μm wavelength light at an incident angle of zero degrees. The reflectivity of the output coupler's reflective coating at 2.94 μm at an incident angle of zero degrees is in the range of 90% to 94%. As such, the partially reflecting face is less reflective than other designs such as Bragagna's design. The high reflector can be coated with a material such that it is highly reflective of light at 2.94 μm at an incident angle of zero degrees. The reflectivity of the high reflector's reflective coating at 2.94 μm at an incident angle of zero degrees can be greater than 99.9% at 2.94 μm. The distance between the output coupler and the high reflector, called the cavity length, can be 146 mm. The output coupler and the high reflector may be angularly tuned in two directions that are normal to the principal axis of the laser rod (e.g., along the vertical axis and along the horizontal axis).

An example of the subject matter described in this disclosure can be implemented in a laser system that includes five pump laser diode packages and a laser rod. All five pump laser diode packages may pump energy into the laser rod to thereby cause the laser to produce a laser beam. The laser rod's diameter may be in the range of 4 mm to 5 mm and the laser rod's length may be in the range of 126 mm to 188 mm. The two end faces of the laser rod can be concave and may have a radius of curvature in the range of 200 mm to 500 mm. The total pump power of the five diode packages may be in the range of 24 kW to 36 kW. The system's output can be a laser beam that consists of a series of pulses. The pulses may be 0.5 ms long pulses at an operating frequency in the range of 100 Hz to 150 Hz and may be 0.3 ms long pulse at an operating frequency in the range of 166 Hz to 250 Hz. The 0.5 ms long pulses may each have an energy in the range of 1.5 J to 2.2 J.

Another example may be implemented as a method. The method can include pumping energy into a laser rod to thereby cause the laser to produce a laser beam that has a maximum average power of at least 220 W. The laser beam can include pulses that each have an energy of 1.5 J to 2.2 J at 0.5 ms.

Yet another example can be implemented as a laser that includes at least one pump laser diode package and a laser rod, wherein at least one pump laser diode package pumps energy into the laser rod to thereby cause the laser to produce a laser beam with a maximum average power of at least 220 W.

In an example, the laser rod is a 50% doped Er:YAG laser rod. In an example the laser rod has a pump power density that is no more than 30 W per cubic mm while the laser rod is producing the laser beam. In an example, the laser rod has a laser rod diameter in the range of 4 mm to 5 mm. In an example a full divergent angle of the laser beam is no more than 50 mrad. In an example, the laser rod is a 50% doped Er:YAG laser rod that has a laser rod diameter in the range of 4 mm to 5 mm. In an example the laser rod is a 50% doped Er:YAG laser rod that has a laser rod diameter in the range of 4 mm to 5 mm and a laser rod length in the range of 126 mm to 188 mm.

In an example, the laser rod is an Er:YAG laser rod, the laser beam has a maximum average power that is at least 220 W, the pump power density of the laser rod is no more than 30 W per cubic mm while the laser is producing the laser beam, the laser rod diameter is in the range of 4 mm to 5 mm, the laser rod has a laser rod length that is in the range of 126 mm to 188 mm, the pumping length of the laser is in the range of 60 mm to 120 mm, and a full divergent angle of the laser beam is no more than 50 mrad.

In an example, the laser beam includes 0.5 ms pulses that each have an energy in the range of 1.5 J to 2.2 J, and the frequency of the pulses is in the range of 100 Hz to 150 Hz. In some examples, five laser diode packages pump energy into the laser rod.

An example of a laser system can include five components: a laser head, one to two laser diode drivers, one to two DC power supplies, a laser controller, and a refrigerating water cooler. The laser head can include laser pump sources and a laser gain medium. The laser pump sources can be five laser diode packages that are quasi continuous and rated to produce, in total, a maximum laser diode power in the range of 24 kW to 36 KW at a maximum duty cycle of 7.5%. The output of the laser diode packages can have a 979 nm center wavelength and a 4 nm bandwidth. The laser gain medium can be an Er:YAG rod that is 50% doped. The diameter of the rod may be in the range of 4 mm to 5 mm, the length of the rod can be in the range of 126 mm to 188 mm. Both of the end faces of the rod are concave. The radius of curvature (ROC) of these concave faces can be in the range of 200 mm to 500 mm with the centers of these ROCs on the center axis of the rod. The concave faces can be anti-reflection coated at 2.94 μm, with a reflectivity that is less than 0.1% at the 2.94 μm wavelength. The concave faces may partially cancel the thermal lensing in the laser rod that is created by the absorption of the light from the laser diode packages. The cancellation of the thermal lensing makes the laser run at high pulse energy and high frequency. The laser system can have a laser cavity that includes a flat output coupler and a flat high reflector. The reflectivity of the flat output coupler can be in the range of 90 to 94% at 2.94 μm. The reflectivity of the flat high reflector can be greater than 99.9% at 2.94 μm. The cavity length (e.g., the distance between the flat output coupler and the flat high reflector) can be 20 mm longer than the length of the laser rod. The output coupler and the high reflector may be angularly tuned in two directions (e.g., vertical and horizontal).

FIG. 1 is a high-level conceptual diagram illustrating an end view of an example of a solid-state laser 100 according to some aspects. The laser 100 has five pumping laser diode packages 102, and a laser rod 101 inside a flow tube 103. The laser diode packages 102 can include laser diode arrays 105 mounted to copper blocks 110 with flow channels 104. A coolant 111, such as chilled water, can flow through the flow channels 104 in the copper blocks 110 to thereby remove heat generated by the laser diode arrays. The coolant can also flow through the flow tube 103 to cool the laser rod 101. The five pumping laser diode packages 102 are the laser pump sources of the laser 100. In one example, the laser rod is a 188 mm long 50% doped Er:YAG laser rod and the laser pump sources provide 36 kW to the laser rod. In another example, the laser rod is a 126 mm long 50% doped Er:YAG laser rod and the laser pump sources provide 24 kW to the laser rod. A 50% doped Er:YAG laser rod can lase at 2.94 μm. The laser rod, flow tube and the five diode packages are held in place by a housing.

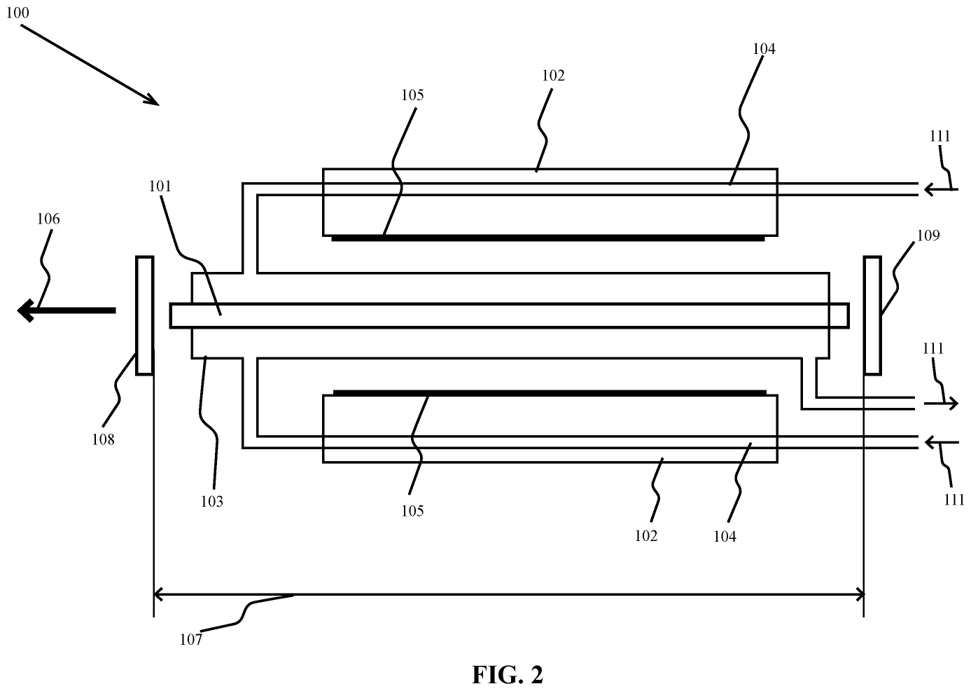

FIG. 2 is a high-level conceptual diagram illustrating a side view of the solid-state laser illustrated in FIG. 1 according to some aspects. Two of the pumping laser diode packages 102, the laser rod 101 and the flow tube 103 are visible. A laser beam 106 that has a wavelength at 2.94 μm is exiting the laser. In one example, a 188 mm laser rod is pumped by pumping laser diode packages 102 that have a 120 mm pumping length. In another example, a 126 mm laser rod is pumped by pumping laser diode packages 102 that have a 60 mm pumping length. The laser has an output coupler 108 and a high reflector 109 on either side of a laser cavity. The laser rod 101 and the flow tube 103 are shown inside the laser cavity. The laser cavity length 107 of the laser cavity is the distance between the output coupler 108 and the high reflector 109.

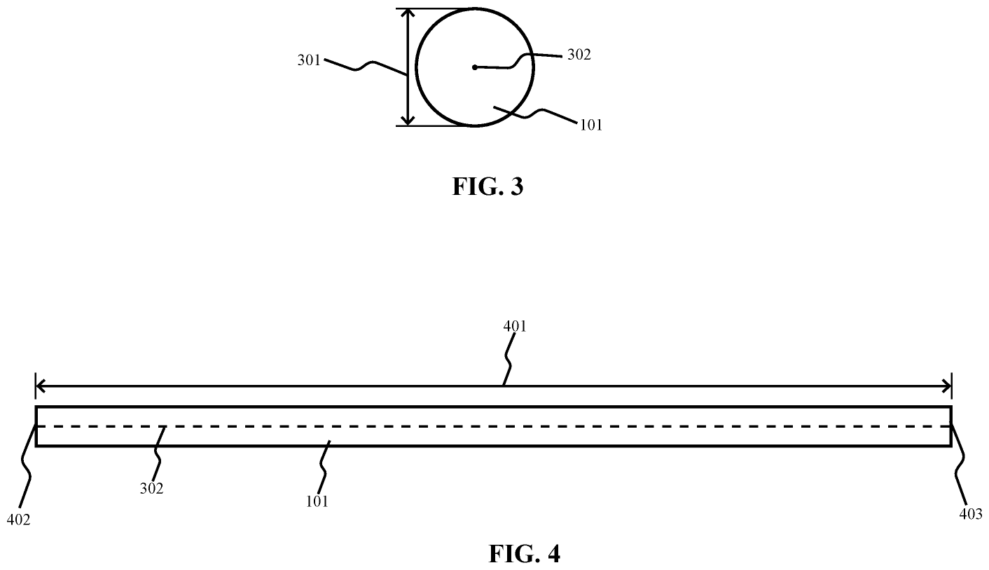

FIG. 3 is a diagram illustrating an end view of a rod of gain media, also called a laser rod 101, according to some aspects. The laser rod 101 has a diameter 301. Some of the examples disclosed herein have laser rods with a 4 mm laser rod diameter. Other examples disclosed herein have laser rods with a 5 mm laser diameter. The laser rod is illustrated as being radially symmetric about a principal axis 302 that runs the length of the laser rod.

FIG. 4 is a diagram illustrating a side view of the laser rod 101 illustrated in FIG. 3 according to some aspects. The laser rod 101 has a length 401, a first end face 402, and a second end face 403. The laser rod 101 can be the laser rod 101 in the exemplary laser 100 illustrated in FIG. 1 and in FIG. 2. An example of a 220 W average power laser has a laser rod that is a 50% doped Er:YAG laser rod having a laser rod length 401 of 188 mm and a laser rod diameter 301 of 5 mm. In another example the laser rod has a laser rod length 401 of 126 mm and a laser rod diameter 301 of 5 mm. In yet another example the laser rod has a laser rod length 401 of 126 mm and a laser rod diameter 301 of 4 mm.

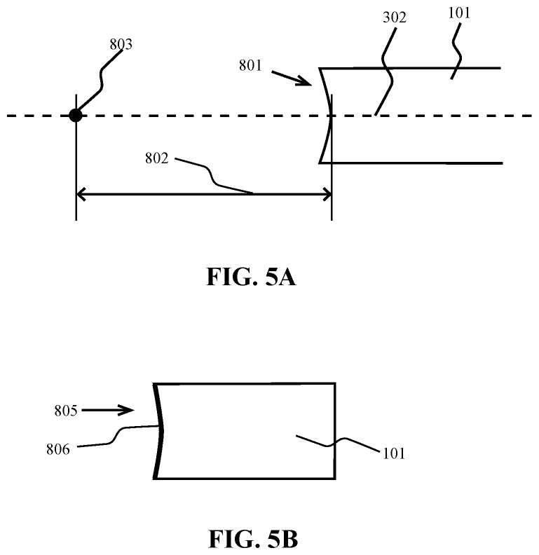

FIG. 5A is a diagram illustrating a concave end 801 of a laser rod 101 according to some aspects. The concave end 801 of the laser rod 101 has a radius of curvature 802 that may be a circular arc centered at a point 803 on the principal axis 302 of the laser rod.

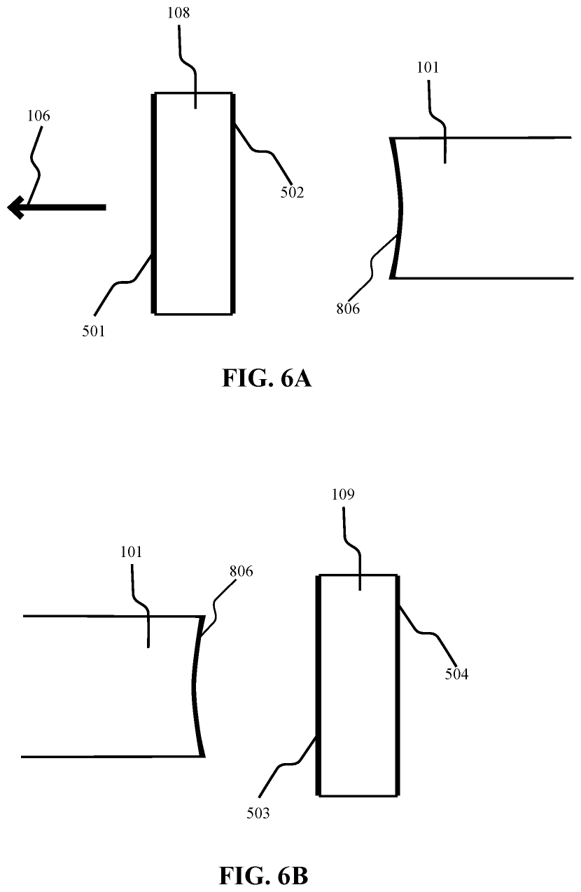

FIG. 5B is a diagram illustrating a concave anti-reflective end 805 of a laser rod 101, according to some aspects. The laser rod 101 has a concave end and the concave end of the laser rod has an anti-reflective coating 806 similar to the anti-reflective coating 501 on the anti-reflective flat of the output coupler 108 illustrated in FIG. 6A.

FIG. 6A is a diagram illustrating an example of an output coupler 108, according to some aspects. One flat of the output coupler 108, the semi reflective flat, has a partially reflective coating 502 and the other flat, the anti-reflective flat, of the output coupler has an anti-reflective coating 501. The anti-reflective flat of the output coupler is anti-reflection coated to have a reflectivity less than 0.1% for light having a 2.94 μm wavelength at a zero-degree angle of incidence. The reflectivity of the partially reflective coating 502 at 2.94 μm at an incident angle of zero degrees is in the range of 90% to 94%. The semi reflective flat of the output coupler 108 faces the concave face of the laser rod. The concave face of the laser rod is anti-reflective coated 806.

FIG. 6B is a diagram illustrating an example of a high reflector 109, according to some aspects. One flat of the high reflector 109 is a fully reflective flat, it has a fully reflective coating 503 and the other flat, the uncoated flat 504 has no coating at all. The fully reflective flat has a fully reflective coating 503. The fully reflective coating 503 is fully reflecting at 2.94 μm and an incident angle of zero degrees. The fully reflective flat of the high reflector faces the concave face of the laser rod. The concave face of the laser rod is anti-reflective coated 806.

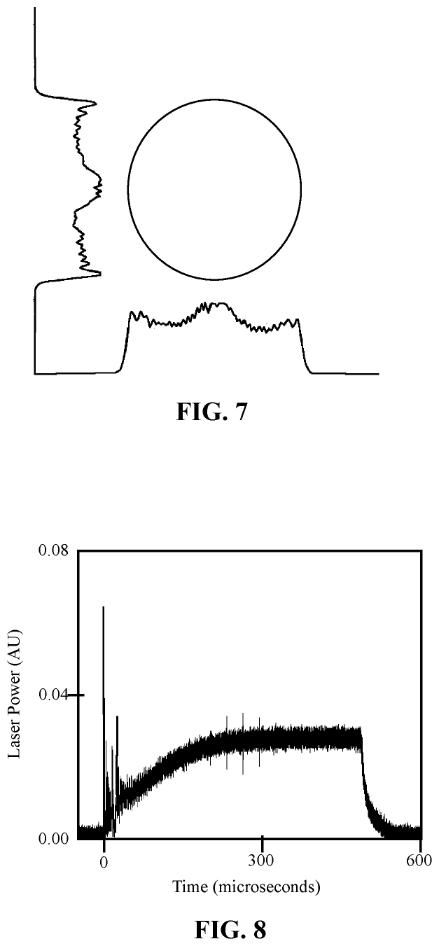

FIG. 7 is a diagram illustrating a top-hat profile of a laser beam that has been achieved using a laser that has an Er:YAG laser rod with a laser rod length of 188 mm and a laser rod diameter of 5 mm, according to some aspects. The laser has a five-axis design such as the laser 100 illustrated in FIG. 1 and FIG. 2. As can be seen, the top-hat profile is excellent for a 220 W average power 2.94 μm laser.

FIG. 8 is a diagram illustrating a temporal profile of the output beam of a laser that has an Er:YAG laser rod with a laser rod length of 188 mm and a laser rod diameter of 5 mm, according to some aspects. As can be seen, the pulse shape is flat for a 220 W average power 2.94 μm laser.

In order to obtain the results shown in FIG. 7 and FIG. 8, a five-axis design such as that shown in FIG. 1 and FIG. 2 was used. In the examples, the laser rod diameter of the Er:YAG laser rod is 5 mm or 4 mm. The laser rod length of the laser rod is 188 mm or 126 mm. The maximum optical power, in total, of the five laser diode packages that pump the laser rod is 36 kW or 24 kW, the pumping optical power density, in the active medium of the laser rod, is in the range of 2 W per mm cubed to 30 W per mm cubed. At this pump density the exemplary lasers can run at 100 Hz to 150 Hz at 0.5 ms pulse duration, the thermal loading in the laser rod creates the thermal lensing effect. Strong thermal lensing can increase the divergence of the laser beam and may push the laser operating point into the unstable region, to compensate for the effect of the thermal lensing, the concave-concave laser rod design is used and the reduction in the thermal lensing pulls the operating point of the laser back into the stable region.

The laser used to obtain the result illustrated in FIG. 7 and FIG. 8 has a laser rod with two concave ends but the laser operates in the stable region because of the thermal lensing in the laser rod that is created by the thermal loading in the laser rod pulls the laser operating point into the stable region. The thermal loading in the laser rod 101 is due to the pumping of the laser diode packages 102. The optical-to-optical efficiency is 14% and the full divergent angle of the output laser beam is 50 mrad at the output of 2.2 J at 0.5 ms at 100 Hz for the 188 mm×5 mm rod laser and 1.5 J at 150 Hz for the 126 mm×5 mm rod laser and the 126 mm×4 mm rod laser.

The material of the laser rods is the 50% doped Er:YAG crystal and its crystal orientation is independent. The dimensions of the laser rods are 5 mm in diameter×188 mm in length, 5 mm in diameter×126 mm in length, and 4 mm in diameter×126 mm in length. The end face configurations of the laser rods can include laser polished concave/concave.

The concave/concave configuration for the 188 mm and 126 mm laser rods can be specified as follows: “S1, S2: concave/concave, Laser Polished (Scratch/Dig (S/D): 10-5 & flatness: lambda/10 at 633 nm, 90% clear aperture, the radius of curvature of the two end faces of the rod is in the range of 200 mm to 500 mm, the centers of these two curvatures are on the axis of the laser rod.

Based on the foregoing, it can be appreciated that a number of embodiments, preferred and alternative, are disclosed herein. It will be appreciated that variations of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is provisionally claimed is:

1. A system comprising:
a laser that includes a laser rod and at least one laser pump source,
wherein:
the laser pump source is configured to pump energy into the laser rod to thereby cause the laser to produce a laser beam that has wavelength of 2.94 μm;
the laser beam has a maximum average power of at least 220 W; and
the laser beam includes a plurality of pulses that each have an energy of at least 1.5 J

2. The system of claim 1 wherein the laser rod is a 50% doped Er:YAG laser rod.

3. The system of claim 1 wherein the laser rod has two concave faces that each have a radius of curvature that is at least 200 mm and no more than 500 mm.

4. The system of claim 3 wherein a pump power density of the laser rod is no more than 30 W per cubic mm while the laser rod is producing the laser beam.

5. The system of claim 4 wherein the laser rod has a laser rod diameter that is at least 4 mm and no more than 5 mm.

6. The system of claim 1 wherein a full divergent angle of the laser beam is no more than 50 mrad.

7. The system of claim 1 wherein the laser rod is a 50% doped Er:YAG laser rod that has a laser rod diameter that is at least 4 mm and no more than 5 mm.

8. The system of claim 1 wherein a pump power density of the laser rod is no more than 30 W per cubic mm while the laser is producing the laser beam.

9. The system of claim 1 wherein the pulses each have an energy of at least 2.2 J.

10. The system of claim 1 wherein the laser rod is a 50% doped Er:YAG laser rod that has a laser rod diameter that is at least 4 mm and no more than 5 mm and a laser rod length that is at least 126 mm and no more than 188 mm.

11. The system of claim 1 wherein:
the laser rod is an Er:YAG laser rod;
a pump power density of the laser rod is no more than 30 W per cubic mm while the laser rod is producing the laser beam;
the laser rod has a laser rod diameter that is at least 4 mm and no more than 5 mm;
the laser rod has a laser rod length that is at least 126 mm and no more than 188 mm;
a pumping length of the laser that is at least 60 mm and no more than 120 mm; and
a full divergent angle of the laser beam is no more than 50 mrad.

12. A method comprising:
pumping energy into a laser rod to thereby cause a laser to produce a laser beam that has wavelength of 2.94 μm,
wherein:
the laser beam has a maximum average power of at least 220 W; and
the laser beam includes a plurality of pulses that each have an energy of at least 1.5 J.

13. The method of claim 12 wherein the laser rod is an Er:YAG laser rod 50% doped.

14. The method of claim 13 wherein a pump power density of the laser rod is no more than 30 W per cubic mm while the laser rod is producing the laser beam.

15. The method of claim 14 wherein the laser rod has a laser rod diameter that is at least 4 mm to 5 mm and laser rod length is in a range of 126 mm and no more than 188 mm.

16. The method of claim 15 wherein a full divergent angle of the laser beam is no more than 50 mrad.

17. A system comprising:
a laser that includes at least one laser pump source, and a laser rod,
wherein:
the laser rod has two concave faces that each have a radius of curvature that is at least 200 mm and no more than 500 mm;
the at least one laser pump source is configured to pump energy into the laser rod to thereby cause the laser to produce a laser beam that has wavelength of 2.94 μm; and
the laser beam has a maximum average power of at least 220 W.

18. The system of claim 17 wherein the laser beam includes a plurality of pulses that each have an energy of at least 1.5 J.

19. The system of claim 17 wherein the at least one laser pump source is five laser diode packages that pump energy into the laser rod.

20. The system of claim 17 wherein the laser further includes a flat output coupler, and a flat high reflector.
